(19) United States
(12) Patent Application Publication
(10) Pub. No.: US 2013/0014126 A1
(43) Pub. Date: Jan. 10, 2013

(54) CROSS-BROWSER COMMUNICATION BETWEEN DEVICES ON A NETWORK

(75) Inventors: Joshua C. Zana, Seattle, WA (US); Jeremy L. Dewey, Duvall, WA (US); Shyam S. Habarakada, Seattle, WA (US)

(73) Assignee: MICROSOFT CORPORATION, Redmond, WA (US)

(21) Appl. No.: 13/176,182

(22) Filed: Jul. 5, 2011

(51) Int. Cl. G06F 9/46

(52) U.S. Cl. 719/313

(57) ABSTRACT

A Web browser of a device on a network identifies itself as being a Web browser on a host device for cross-browser communications. As part of this identification, the Web browser of the host device provides access information indicating how to communicate with the Web browser. Other computing devices on the same network can obtain this access information, and Web applications running in Web browsers of those other computing devices can use the obtained access information to communicate data to the Web browser of the host device.

### BACKGROUND

Computing devices have become increasingly commonplace, with people oftentimes having multiple different computing devices. For example, people can have portable computers, smart phones, tablet computers, and so forth. While these computing devices provide various benefits to users, they are not without their problems. One such problem is that it can be difficult for a user to easily allow these different devices to communicate with one another. These difficulties can result in a user experience that is frustrating or otherwise unfriendly for the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, at a computing device access information indicating how to communicate with a Web browser of a host device on a same local area network as the computing device is obtained. The access information is used to communicate data from a Web application of a Web browser of the computing device to a Web application running in the Web browser of the host device.

In accordance with one or more aspects, a first computing device is identified as a host device having a first Web browser supporting cross-browser communications from Web browsers of other computing devices on a same local area network as the first computing device. Data is received from a Web application being run by a second Web browser of a second computing device, and is provided to a Web application being run by the first Web browser.

### BRIEF DESCRIPTION OF THE DRAWINGS

The same numbers are used throughout the drawings to reference like features.

FIG. 1 illustrates an example system implementing the cross-browser communication between devices on a network in accordance with one or more embodiments.

FIG. 2 illustrates example devices in additional detail implementing the cross-browser communication between devices on a network in accordance with one or more embodiments.

FIG. 3 is a flowchart illustrating an example process for implementing cross-browser communication between devices on a network in accordance with one or more embodiments.

FIG. 4 is a flowchart illustrating another example process for implementing cross-browser communication between devices on a network in accordance with one or more embodiments.

FIG. 5 illustrates an example computing device that can be configured to implement the cross-browser communication between devices on a network in accordance with one or more embodiments.

### DETAILED DESCRIPTION

Cross-browser communication between devices on a network is discussed herein. A Web browser of a device on a local area network (LAN) identifies itself as being a Web browser on a host device for cross-browser communications. As part of this identification, the Web browser of the host device provides access information indicating how other Web browsers of other devices on the same LAN can communicate with the Web browser on the host device. Other devices on the same LAN can obtain this access information, and Web applications running in Web browsers of those other devices can use the obtained access information to communicate data to the Web browser of the host device. The Web browser of the host device can provide received data to the appropriate Web application running in the Web browser of the host device, and optionally return responses to the Web application from which the data was received.

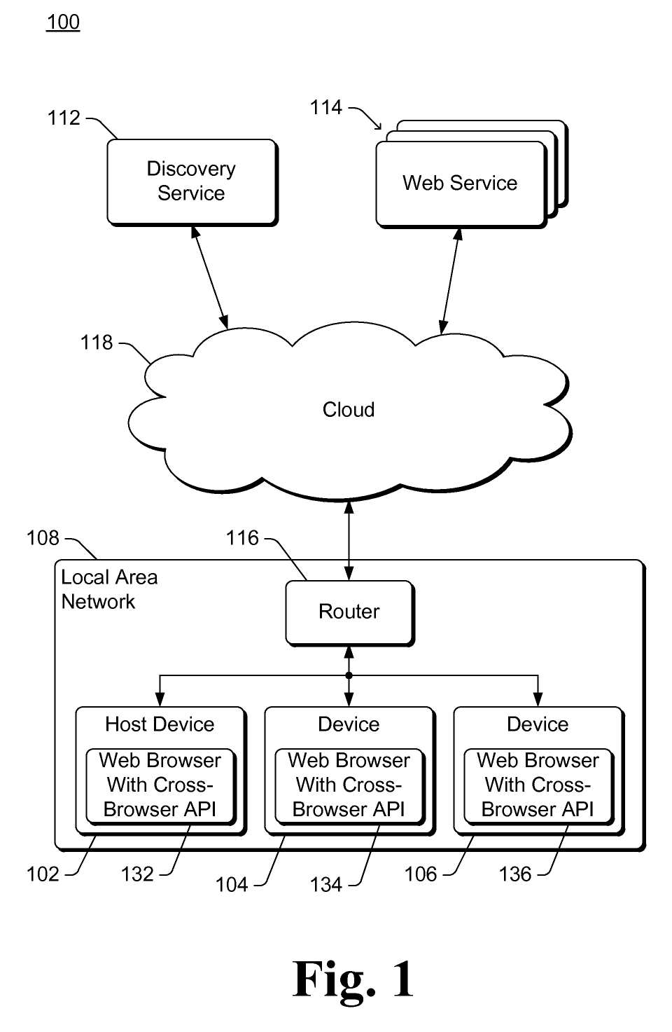

FIG. 1 illustrates an example system 100 implementing the cross-browser communication between devices on a network in accordance with one or more embodiments. System 100 includes a host device 102 and multiple additional devices 104, 106 that are part of a local area network (LAN) 108. Although a single host device 102 and two additional devices 104, 106 are illustrated in FIG. 1, it should be noted that any number of host devices and any number of additional devices can be included in local area network 108.

Host device 102, as well as each additional device 104, 106, can be a variety of different types of computing devices. For example, a device 102, 104, or 106 can be a desktop computer, a server computer, a laptop or netbook computer, a tablet or notepad computer, a mobile station, an entertainment appliance, a set-top box communicatively coupled to a display device, a television or other display device, a smart phone or other wireless phone, a game console, an automotive computer, and so forth. Thus, each device 102, 104, and 106 may range from a full resource device with substantial memory and processor resources (e.g., personal computers, game consoles) to low-resource devices with limited memory and/or processing resources (e.g., traditional set-top boxes, hand-held game consoles). Different ones of devices 102, 104, and 106 can be the same type and/or different types of computing devices.

Devices 102, 104, and 106 are part of local area network 108 and can communicate with one another (e.g., via wired and/or wireless connections). Additionally, devices 102, 104, and 106 can communicate with a discovery service 112 and/or one or more other web services 114 via router 116 and cloud 118. Router 116 is a communication gateway between local area network 108 and devices not included in local area network 108. Communications targeting a device 102, 104 or 106 from another device not in local area network 108 pass through router 116. Similarly, communications from a device 102, 104 or 106 targeting another device not in local area network 108 also pass through router 116.

Cloud 118 represents various communications devices and/or communication networks. For example, cloud 118 can include various devices (e.g., routers, bridges, gateways, server computers, etc.) and/or various networks (e.g., the Internet, other local area networks, a telephone network, an intranet, other public and/or proprietary networks, combinations thereof, etc.).

Discovery service 112 provides discovery functionality to devices 102, 104, and 106, allowing host device 102 to register itself for discovery and allowing devices 104, 106 to identify host device 102 as having been registered as a host device. The use of discovery service 112 is discussed in additional detail below. Web services 114 provide various additional functionality to devices 102, 104, and 106, such as entertainment functionality, utility or productivity functionality, reference functionality, and so forth. Web services 114 can optionally provide one or more Web applications to devices 102, 104, and/or 106 that can communicate with one another using the cross-browser communication between devices on a network techniques discussed herein.

Discovery service 112 and each web service 114 are each implemented by one or more computing devices. Each service 112 and 114 can be implemented using a variety of different types of computing devices, ranging from full resource devices with substantial memory and processor resources to low-resource devices with limited memory and/or processing resources, such as any of the types of computing devices discussed above with reference to devices 102, 104, and 106. Services 112 and 114 can be implemented using the same types of devices and/or different types of devices.

Devices 102, 104, and 106 each include a Web browser with a cross-browser application programming interface (API) 132, 134, and 136, respectively. Web browser 134 can communicate with Web browser 132 of host device 102, allowing Web applications of Web browser 134 to communicate with Web applications of Web browser 132. Similarly, Web browser 136 can communicate with Web browser 132 of host device 102, allowing Web applications of Web browser 136 to communicate with Web applications of Web browser 132. These cross-browser communications are discussed in more detail below.

The cross-browser communications discussed herein refer to communications between devices on or part of the same network. For example, discussion regarding communications between ones of devices 102, 104, and 106 that are on or are part of local area network 108. The particular network that a device is on or is part of refers to the initial network (at any given time) that the device communicates with (e.g., the network for which a network address (e.g., Internet Protocol (IP) address) is assigned to the device). It should be noted that a device can communicate with multiple networks and thus can be viewed as being coupled to multiple networks at the same time, but the initial network that the device communicates with at any given time is the network that the device is on or is part of. It should also be noted that the initial network that the device communicates with can change over time (e.g., as the device moves). For example, the initial network that the device communicates with can be a home LAN (and the device can be assigned an IP address from a router of the home LAN), and through that home LAN the device can access the Internet and a corporate LAN. Even though the device is coupled to and can communicate with the Internet and corporate LAN, the device is viewed as being on or as being part of the home LAN.

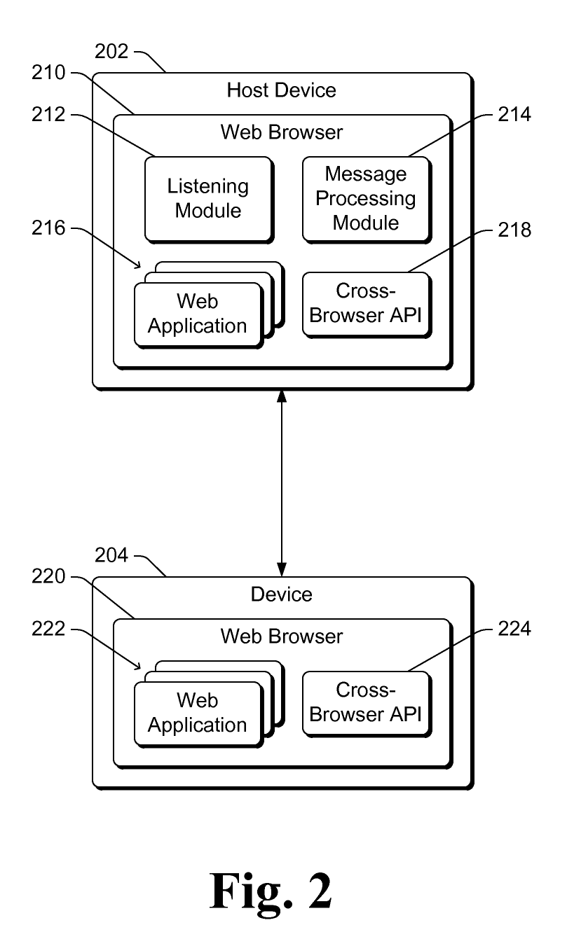

FIG. 2 illustrates example devices in additional detail implementing the cross-browser communication between devices on a network in accordance with one or more embodiments. FIG. 2 illustrates a host device 202 (which can be a host device 102 of FIG. 1) and an additional device 204 (which can be an additional device 104 of FIG. 1). Devices 202 and 204 can be a variety of different types of devices, analogous to the discussion above regarding devices 102 and 104 of FIG. 1. Devices 202 and 204 are both on the same network, such as being included as part of local area network 108 of FIG. 1.

Host device 202 includes a Web browser 210, which includes a listening module 212, a message processing module 214, one or more Web applications 216, and a cross-browser API 218. Device 204 includes a Web browser 220, which includes one or more Web applications 222 and a cross-browser API 224. Web applications of a Web browser refer to programs that are run, executed, etc. in a Web browser. Web applications can be written in a variety of different languages or based on a variety of different technologies, such as programs written for the Silverlight® framework, Java programs, JavaScript programs, Asynchronous JavaScript (AJAX) programs, and so forth. Web applications can be obtained from a Web service (e.g., a Web service 114 of FIG. 1), or alternatively from other sources.

Generally, the cross-browser communication between devices on a network discussed herein is implemented as a two-part process. The first part is a discovery process in which Web browsers supporting cross-browser communication on host devices on a network are identified, and access information indicating how other Web browsers can access the Web browsers on the host devices is obtained. For example, Web browser 210 on host device 202 is identified as supporting cross-browser communication, and access information indicating how Web browser 220 can access Web browser 210 is obtained. The second part is a communication part in which Web applications in a Web browser of a device communicate with Web applications in a Web browser of the host device on the same network. For example, Web browser 220 uses the access information obtained for Web browser 210 to allow cross-browser communication between Web browser 220 and Web browser 210, allowing Web applications 222 to communicate with Web applications 216.

During the discovery process, Web browser 210 identifies itself as being a Web browser of a host device, and makes available access information for Web browser 210. The access information for Web browser 210 indicates how Web browsers of other devices on the same network as host device 202 can communicate with Web browser 210. Web browser 210 can identify itself as being a Web browser of a host device at various times, such as when Web browser 210 is initialized or begins running, or in response to other events such as an input from a user of host device 202, detection of a network that host device 202 is on (e.g., where host device 202 was not previously on a network or was previously on a different network), detection of a new device on the same network as host device 202, and so forth.

The access information that Web browser 210 makes available during the discovery process can include various different data, such as a network address (e.g., an IP address) of host device 202 on the network. This network address refers to the network address assigned to host device 202 for the network that the host device is on (e.g., referring to FIG. 1, an IP address on local area network 108 assigned to host device 102 by router 116). The access information can alternatively take other forms, such as a HyperText Transfer Protocol (HTTP) service endpoint address of Web browser 210 on the network, a uniform resource identifier (URI) of Web browser 210 on the network, and so forth.

The discovery process can be performed in different manners. In one or more embodiments, Web browser 210 registers itself with a discovery service, such as discovery service 112 of FIG. 1. An address of the discovery service is known to both host device 202 and device 204, allowing both devices 202 and 204 to access the discovery service. As part of this registration, Web browser 210 provides the access information indicating how other Web browsers can access Web browser 210, as well as an identifier of the network that host device 202 is on. Each of multiple other Web browsers in other devices can request and receive, from the discovery service, an indication of one or more host devices on the same network as the device including the other Web browser. For example, Web browser 220 can request, from the discovery service, an indication of one or more host devices (or Web browsers on host device) on the same network as device 204. In response to such a request, the discovery service identifies host device 202 on the same network as the requesting device 204, Web browser 210 having registered with the discovery service. The discovery service returns to requesting device 204 an identifier of host device 202 (and/or Web browser 210) and the access information indicating how Web browser 220 can access Web browser 210.

The identifier of the network that host device 202 is on (as provided to the discovery service) can take a variety of different forms. For example, the identifier can be a name assigned to the network (e.g., by a router on the network, such as router 116 of FIG. 1). The identifier of the network is used to differentiate networks that host devices are on from one another by the discovery service. The identifiers of the networks can take various forms and can be assigned in various manners, as long as requests to register a host device on a particular network and requests to identify host devices on the particular network refer to the same network.

Alternatively, the discovery process can be performed in other manners rather than using a discovery service, such as performing a LAN-based discovery process. For example, the discovery process can be based on a Bluetooth discovery process, an Address Resolution Protocol (ARP) discovery process, a Simple Service Discovery Protocol (SSDP) discovery process, and so forth.

In one or more embodiments, the discovery process includes various authentication or authorization mechanisms to verify that a device is permitted to access a host device. A device (or user of a device) verifies that the device (or user) is permitted to access the host device by proving knowledge of valid credentials, such as a secret phrase (e.g., password) associated with the host device, a private key corresponding to a certificate (e.g., of the device or a user of the device), logging into both the device and the host device with the same user name or identifier, and so forth. As part of the discovery process, an identifier of the host device is returned to a requesting device only if the requesting device verifies that the requesting device is permitted to access the host device.

Alternatively, no such authentication authorization mechanism need be used. For example, no verification may be performed, or verification that the requesting device is permitted to access the host device can be inherent in both the requesting device and the host device being on the same network.

Regardless of the type of discovery process used, host device 202 is identified as having Web browser 210 supporting cross-browser communication on a particular network, and access information indicating how Web browser 210 can be accessed by Web browser 220 is obtained by Web browser 220. Web browser 220 provides a cross-browser API 224 to Web applications 222, allowing Web applications 222 to invoke cross-browser API 224 to send data to, and receive data from, Web applications 216. The data sent and received by Web applications 222 can take various forms, such as commands, instructions, data to be displayed, data indicating how other information is to be displayed, and so forth.

In one or more embodiments, the cross-browser communication uses an HTTP based message channel via which the data is communicated between devices 202 and 204 (e.g., using HTTP messages). Alternatively, message channels can be established using other technologies other than HTTP.

When a Web application 222 desires to send data to a Web application 216, Web application 222 invokes cross-browser API 224 to obtain access information for Web browser 210. Web application 222 also invokes cross-browser API 224 to communicate data to Web browser 210, and along with the data also optionally sends to Web browser 210 an indication of one or more Web applications 216 to which the data is being sent.

Web browser 220 sends the data from Web application 222 to host device 202 based on the access information for Web browser 210. Listening module 212 receives data sent from Web browser 220. For example, listening module 212 can implement an HTTP service endpoint having an address identified in the access information for Web browser 210. Data received by listening module 212 is provided to message processing module 214, which identifies the particular Web application 216 to which the received data is to be provided. Included or otherwise associated with the data received from Web browser 220 can be an identifier of the particular Web application 216 that the data is to be provided to. Alternatively, the particular Web application 216 to which the received data is to be provided can be identified in other manners, such as having different listening modules 212 associated with different Web applications 216. Alternatively, if Web browser 210 includes only a single Web application 216, then all data received from Web browser 220 can be provided to that single Web application 216 (e.g., by message processing module 214 or by listening module 212).

The Web application 216 that receives the data can optionally return a response to the received data. This response is returned by Web browser 210 (e.g., by message processing module 214 in Web browser 210) to Web browser 220, which returns the response (e.g., an HTTP response) to the Web application 222 that sent the data to Web browser 210.

In one or more embodiments, Web browser 210 includes cross-browser API 218 exposed to Web applications 216, and Web browser 220 includes cross-browser API 224 exposed to Web applications 222. APIs 218 and 224 can be the same APIs, including the same methods as discussed below.

In one or more embodiments, the cross-browser API (e.g., API 218 and/or API 224) includes a host discovery method, a host determination method, a notification method, and a message communication method.

The host discovery method can be invoked by a Web application 222 to identify host device 202 (and/or Web browser 210) on the same network as the device running the Web application (device 204). In response to the host discovery method being invoked, Web browser 220 identifies host device 202 and/or Web browser 210 (e.g., by accessing a discovery service as discussed above), and returns an indication of host device 202 and/or Web browser 210 to the Web application 222. Access information indicating how to access Web browser 210 can be returned to the Web application, or alternatively maintained and used by Web browser 220 to send data to Web browser 210 without revealing the access information to Web application 222.

Additionally, host device 202 can have a descriptive name that allows host device 202 to be identified in a user friendly manner (e.g., “Bedroom Television”, “Family Room DVR”, etc.). This descriptive name can be identified in different manners, such as being provided by Web browser 210 and included as part of (or obtained along with) the access information obtained during the discovery process. Web applications 222 can display this descriptive name to users as part of a user interface (e.g., to facilitate in identifying a host device running Web applications to which data is to be sent).

In one or more embodiments, the host discovery method is a “discoverHosts” method having a callback parameter. The Web application 222 invokes the discoverHosts method, specifying as the callback parameter a function to be invoked by Web browser 220. Web browser 220 identifies the host devices using the discovery process, and provides to the function specified as the callback parameter an identifier of the identified host devices (optionally including descriptive names and/or access information).

The host determination method can be invoked by a Web application to determine whether the Web browser running the Web application is running on a host device. In response to the host determination method being invoked, the Web browser returns a value indicating whether the Web browser running the Web application is running on a host device. This allows, for example, different Web applications to behave or operate in different manners depending on whether they are running in a Web browser on a host device or another device.

In one or more embodiments, the host determination method is an “isHost” method. The Web application invokes the isHost method, and in response the Web browser running the Web application returns a value of true if the Web browser is running on a host device, and returns a value of false if the Web browser is not running on a host device.

The notification method can be invoked by a Web application to indicate that the Web application is to be notified when data for the Web application is received. In response to the notification method being invoked, the Web browser (e.g., message processing module 214 of Web browser 210) maintains a record of the Web application, and notifies the Web application when data for the Web application is received.

In one or more embodiments, the notification method is an “addEventListener” method having a message parameter and a callback parameter. The Web application invokes the addEventListener method, specifying the message parameter to indicate that a function specified as the callback parameter is to be invoked by the Web browser when data for the Web application from another Web browser is received. The Web browser maintains a record of the parameters provided by the Web application, and when data for the Web application is received from another Web browser, provides the received data to the specified function.

The message communication method can be invoked by a Web application to send data to a Web application of another Web browser. The Web application sending the data specifies the data, the host device (or Web browser on the host device) to which the data is to be sent, and optionally one or more Web applications running in a Web browser on that host device to which the data is to be sent.

In one or more embodiments, the message communication method is a “postMessage” method having a message parameter, a target id parameter, and a target origin parameter. The Web application invokes the postMessage method, including the data to be sent as the message parameter. The Web application includes an identifier of the host device to which the data is to be sent as the target id parameter. The Web application includes an identifier of one or more Web applications to which the data is to be sent as the target origin parameter. Various global characters can optionally be used in the target id parameter and/or target origin parameter. For example, a value of “*” as the target origin parameter can be used to specify that the data is to be sent to all Web applications running in a Web browser of the host device specified in the target id parameter.

In response to the postMessage method being invoked (e.g., by a Web application 222), the Web browser (e.g., Web browser 220) sends the data to the host device identified in the target id parameter. The one or more identifiers specified as the target origin parameter can also be sent to the host device, indicating to a message processing module on the host device (e.g., message processing module 214) one or more Web applications (e.g., Web applications 216) to receive the data.

A Web application on the host device receiving data can also optionally return data in response to the received data. This response can be returned in different manners. For example, Web browser 220 can send the data to Web browser 210 using an HTTP post message, and in response to the HTTP post message Web browser 210 can send to Web browser 220 an HTTP response message including the data from a Web application 216.

Although FIG. 2 is discussed with reference to a single host device 202 and a single additional device 204, it should be noted that the cross-browser communication between devices on a network techniques discussed herein can be used with any number of devices. For example, any number of host devices 202 can be on the same network and communicated with by Web applications 222 running in Web browser 220. By way of another example, any number of additional devices 204 can be on the same network and running Web applications in Web browsers communicating with Web browser 210.

It should also be noted that the cross-browser communication between devices on a network techniques discussed herein can be readily incorporated into various Web browsers. For example, conventional Web browsers can be easily expanded to include the cross-browser communication between devices on a network techniques discussed herein by incorporating a script file that includes the cross-browser APIs discussed herein (as well as a listening module and/or message processing module in the host device if not already included). Thus, significant changes to existing Web browsers can be avoided when implementing the cross-browser communication between devices on a network techniques discussed herein.

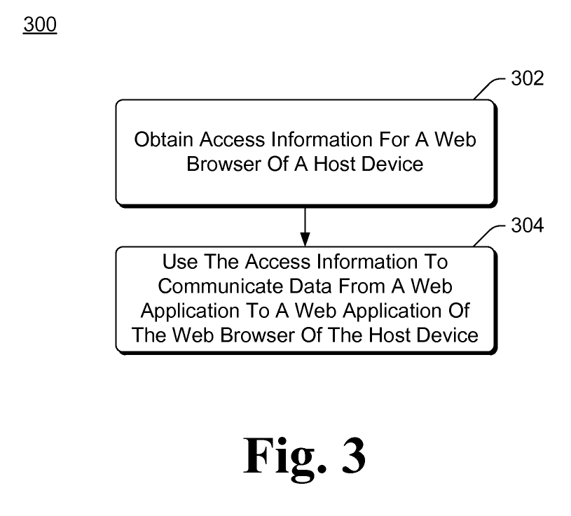

FIG. 3 is a flowchart illustrating an example process 300 for implementing cross-browser communication between devices on a network in accordance with one or more embodiments. Process 300 is carried out by a device accessing a host device, such as a device 104 or 106 of FIG. 1, or a device 204 of FIG. 2, and can be implemented in software, firmware, hardware, or combinations thereof. Process 300 is shown as a set of acts and is not limited to the order shown for performing the operations of the various acts. Process 300 is an example process for implementing cross-browser communication between devices on a network; additional discussions of implementing cross-browser communication between devices on a network are included herein with reference to different figures.

In process 300, access information for a Web browser of a host device is obtained (act 302). The access information indicates how Web browsers of other devices on the same network as the host device can communicate with the Web browser of the host device, as discussed above.

The obtained access information is used to communicate data from a Web application of a Web browser of the device implementing process 300 to a Web application of the Web browser of the host device (act 304). These Web applications are, for example, running in their respective Web browsers as discussed above. Additionally, various APIs can be exposed to facilitate this communication in act 304, as discussed above.

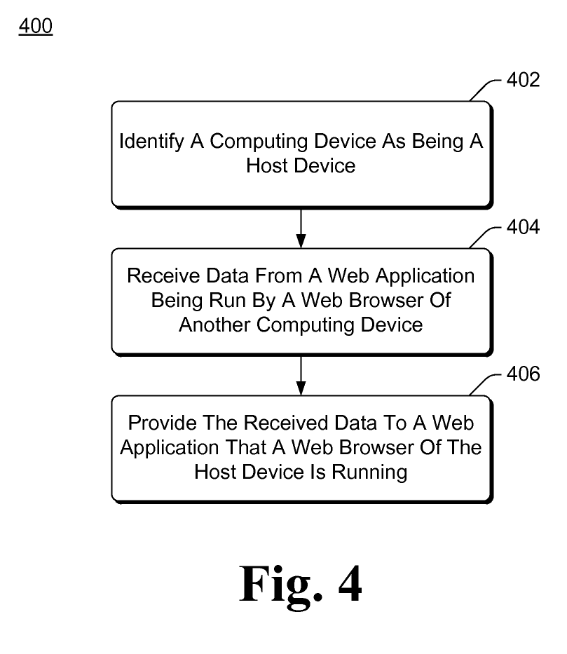

FIG. 4 is a flowchart illustrating an example process 400 for implementing cross-browser communication between devices on a network in accordance with one or more embodiments. Process 400 is carried out by a host device, such as a host device 102 of FIG. 1, or a host device 202 of FIG. 2, and can be implemented in software, firmware, hardware, or combinations thereof. Process 400 is shown as a set of acts and is not limited to the order shown for performing the operations of the various acts. Process 400 is an example process for implementing cross-browser communication between devices on a network; additional discussions of implementing cross-browser communication between devices on a network are included herein with reference to different figures.

In process 400, the computing device implementing process 400 identifies itself as being a host device (act 402). This identification can be performed in a variety of different manners as part of a discovery process, as discussed above. This identifying includes providing access information indicating how Web browsers of other devices on the same network as the host device can communicate with a Web browser of the host device, as discussed above.

Data from a Web application being run by a Web browser of another computing device is received (act 404). The computing device from which the data received is another device on the same network as the host device, as discussed above.

The received data is provided to a Web application that a Web browser of the host device is running (act 406). The Web application to which the received data is to be provided can be identified in different manners, such as being identified as part of the received data as discussed above.

The cross-browser communication between devices on a network techniques discussed herein support various usage scenarios. For example, a host device can be a television and another device can be a smart phone. Both the television and the smart phone can include Web browsers running Web applications allowing playback of audio/video content (e.g., movies, television shows, etc.). The Web application on the smart phone can use the techniques discussed herein to send data to the television to select audio/video content for display by the Web application on the television, send data to the television to control playback of the audio/video content by the Web application on the television, and so forth.

Various actions such as communicating, receiving, sending, obtaining, and so forth performed by various modules are discussed herein. A particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

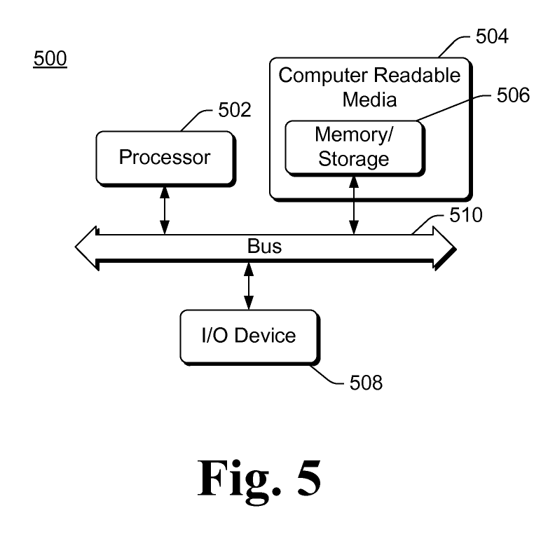

FIG. 5 illustrates an example computing device 500 that can be configured to implement the cross-browser communication between devices on a network in accordance with one or more embodiments. Computing device 500 can, for example, be a device 102, 104, or 106 of FIG. 1, implement at least part of service 112 or 114 of FIG. 1, or be a device 202 or 204 of FIG. 2.

Computing device 500 includes one or more processors or processing units 502, one or more computer readable media 504 which can include one or more memory and/or storage components 506, one or more input/output (1/0) devices 508, and a bus 510 that allows the various components and devices to communicate with one another. Computer readable media 504 and/or one or more I/O devices 508 can be included as part of, or alternatively may be coupled to, computing device 500. Bus 510 represents one or more of several types of bus structures, including a memory bus or memory controller, a peripheral bus, an accelerated graphics port, a processor or local bus, and so forth using a variety of different bus architectures. Bus 510 can include wired and/or wireless buses.

Memory/storage component 506 represents one or more computer storage media. Component 506 can include volatile media (such as random access memory (RAM)) and/or nonvolatile media (such as read only memory (ROM), Flash memory, optical disks, magnetic disks, and so forth). Component 506 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 502. It is to be appreciated that different instructions can be stored in different components of computing device 500, such as in a processing unit 502, in various cache memories of a processing unit 502, in other cache memories of device 500 (not shown), on other computer readable media, and so forth. Additionally, it is to be appreciated that the location where instructions are stored in computing device 500 can change over time.

One or more input/output devices 508 allow a user to enter commands and information to computing device 500, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, applications, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communication media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. Computer storage media refer to media for storage of information in contrast to mere signal transmission, carrier waves, or signals per se. Thus, computer storage media refers to non-signal bearing media, and is not communication media.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 5. The features of the cross-browser communication between devices on a network techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a computing device, the method comprising:
obtaining, in the computing device, access information indicating how to communicate with a first Web browser of a host device on a same local area network as the computing device, the first Web browser running a first Web application; and
using the access information to communicate data to the first Web application from a second Web application of a second Web browser of the computing device.

2. A method as recited in claim 1, the host device having registered itself with a discovery service including providing the access information to the discovery service, and the obtaining comprising obtaining the access information from the discovery service.

3. A method as recited in claim 2, the obtaining further comprising accessing the discovery service over the Internet.

4. A method as recited in claim 1, the obtaining comprising obtaining the access information only if the computing device is verified as being permitted to access the host device.

5. A method as recited in claim 1, the access information comprising a HyperText Transfer Protocol (HTTP) service endpoint address of the first Web browser.

6. A method as recited in claim 1, the obtaining comprising obtaining, for each of one or more additional host devices on the same local network as the computing device, access information indicating how to communicate with a Web browser of the additional host device.

7. A method as recited in claim 1, the obtaining comprising obtaining the access information in response to a host discovery Application Programming Interface (API) method being invoked by the second Web application.

8. A method as recited in claim 1, further comprising returning to the second Web application in response to the second Web application invoking a host determination Application Programming Interface (API) method, an indication of whether the second Web browser is running on a host device.

9. A method as recited in claim 1, the using comprising using the access information to communicate data to the first Web application from the second Web application in response to a message communication Application Programming Interface (API) method being invoked by the second Web application.

10. A method as recited in claim 9, the first Web browser running multiple Web applications including the first Web application, the using further comprising using the access information to communicate an identifier of the first Web application as the one of the multiple Web applications to receive the data.

11. A method implemented in a first computing device, the method comprising:
identifying the first computing device as a host device having a first Web browser supporting receiving cross-browser communications from Web browsers of other computing devices on a same local area network as the first computing device, the first Web browser running a first Web application;
receiving data from a second Web application being run by a second Web browser of a second computing device, the second computing device being one of the other computing devices; and
providing the data to the first Web application.

12. A method as recited in claim 11, the providing comprising providing the data to a function of the first Web application identified by the first Web application invoking a notification Application Programming Interface (API) method.

13. A method as recited in claim 11, the identifying comprising providing access information indicating how the second Web browser can communicate with the first Web browser.

14. A method as recited in claim 13, the providing access information comprising providing access information to a discovery service accessible to the second computing device.

15. A method as recited in claim 14, the providing access information further comprising providing the access information to the discovery service over the Internet.

16. A method as recited in claim 11, the first Web browser running multiple Web applications, the method further comprising identifying, based on an identifier associated with the data, which of the multiple Web applications is the first Web application.

17. A method as recited in claim 11, further comprising:
receiving, from the first Web application, response data; and
returning the response data to the second Web application.

18. A method as recited in claim 11, further comprising:
receiving data from a third Web application being run by a third Web browser of a third computing device, the third computing device being one of the other computing devices; and
providing the data received from the third Web application to the first Web application.

19. A method as recited in claim 11, the access information comprising a HyperText Transfer Protocol (HTTP) service endpoint address of the first Web browser.

20. One or more computer storage media having stored thereon multiple instructions that, when executed by one or more processors of a computing device, cause the one or more processors to:
obtain, in response to a host discovery Application Programming Interface (API) method being invoked by a first Web application of a first Web browser of the computing device, access information indicating how to communicate with a second Web browser of a host device on a same local area network as the computing device, the second Web browser running a second Web application, the access information comprising a HyperText Transfer Protocol (HTTP) service endpoint address of the second Web browser; and
use, in response to a message communication API method being invoked by the first Web application, the access information to communicate from the first Web application to the second Web application both data and an identifier of the second Web application, the second Web application being one of multiple Web applications being run by the second Web browser.
